(19) United States
(12) Patent Application Publication
(10) Pub. No.: US 2006/0070124 A1
(43) Pub. Date: Mar. 30, 2006

(54) Rights management

(75) Inventors: Wolfgang Arndt, Langenfeld (DE); Joachim Bochmann, Duisburg (DE); Frank Scheler, Langenfeld (DE)

Correspondence Address: NORRIS, MCLAUGHLIN & MARCUS, 875 THIRD AVE, 18TH FLOOR, NEW YORK, NY, 10022, US

(73) Assignee: Bayer Business Services GmbH, Leverkusen (DE)

(21) Appl. No.: 11/233,788

(22) Filed: Sep. 23, 2005

(30) Foreign Application Priority Data
Sep. 29, 2004 (DE) 10 2004 04 71460

(51) Int. Cl. G06F 12/14

(52) U.S. Cl. 726/17

(57) ABSTRACT

A device and a method with a memory for the storage of data with a means for limiting the access rights to the data for a user. Usernames provided at authentication posse specific user rights, such as super administrator rights or independent inheritance rights. Thus the rights management is simplified to a certain degree, since the administrator is not required to assign rights to additional users. Furthermore, a temporal process of rights control is provided, whereby the administrator is not required to controlling the granting or terminating rights.

### RIGHTS MANAGEMENT

The present invention relates to a device with a memory for the storage of data with a means for limiting the access rights to the data for a user.

With known devices for the management and/or processing of data, in particular of a database, it has proven to be a disadvantage that the allocation of the access rights associated with it is limited too strictly to individual users or a few users, administrators in particular. The administrator is thus required for even the most minor changes, on account of the access rights. This disrupts operational activity considerably such that the need exists for a delegation of the effort associated with the allocation of access rights, for an administrator for example.

Against the background of the disadvantages described above, the object of the present invention is to create a system as well as a method with simplified and improved rights management and allocation.

This object is achieved by means of a generic device with the features of Claim 1 as well as with the method according to the equivalent Claim. Advantageous embodiments arise out of the subclaims.

The device according to the invention has memory for the storage of data. For example, it has a main memory or a data memory, for example in the form of a hard drive. The data involve data, for example, that are entered into the device and that are connected to commercial processes, for example. In addition, it can also involve correspondence and writings that exist in digital form and that can be allocated to each individual process and are stored in a recallable manner.

In addition, means for limiting the access rights to data for a user are provided. At the same time, it can involve a device with an associated database that ensures that not everyone can do everything on the device, but rather than one is given authorization for individual objects (files, folders, printers, computers), such that controlled access to these objects is possible. For example, the process is designed for the purpose of access, so-called “authentication”, as follows: after provision of the user name of the user, a password is entered. The mechanism in the system that determines whether an authentication was successful (access granted) or not (access prohibited), is stored in the database, which knows a particular number of users and their passwords as well. In addition to this type of authentication, additional technical mechanisms are known, with which authentication is achieved, for example biometric systems, card- or key systems and so forth. In addition to the individual users, there can also be so-called user groups, by which the centralisation in groups with specific rights simplifies the administration of large devices with multiple users. In addition to access to objects and resources, certain additional rights are specified, which relate not to specific objects, but rather that describe a right to carry out specific actions in a certain way. These rights are also called “privileges,” and one can assign them to users or groups.

According to a further advantageous embodiment, the means for limiting the access rights provide for temporal control. Thus a temporary allocation or withdrawal of access rights is achieved. For example, access rights can be limited in whole or in part to objects or resources based on the passage of a predetermined amount of time, without at the same time disabling access, for example, through the expiration of the password. The management of the access rights are thus comparatively quite flexible and simple, since no one with corresponding rights such as, for example, an administrator, is required to change the rights of a user or, if necessary, for deleting the user from a specific user group.

In a further advantageous embodiment of the device according to the invention, the means for limiting the access rights are designed in such a way that a user, a so-called super administrator, is ensured unlimited access to the data. This means, for example, that this super administrator himself has access rights to the application data stored by the system. This is advantageous for monitoring the processes managed with the system, for example in the evaluation phase of the device.

In a further advantageous embodiment of the device according to the invention, means for display are provided, which show at minimum an allocation between user and access rights. For example, it is obvious to everyone which persons, i.e. which usernames provided at authentication now possess super administrator rights. Thus the transparency of the system is increased for all users on the one hand, and on the other had it is ensured that no misuse is made of the granted rights because of the lack of anonymity. In order to further increase the protection against misuse, the rights associated with the position of super administrator can be limited temporally as already described above.

According to a further advantageous embodiment, the means for limiting the access rights are designed such that no user is granted unlimited access, i.e. is limited with respect to his rights such that no access to all parts of the data, resources and/or objects is granted. Data security for the device, for example in ongoing operation, is thereby increased. In addition, individual, separate administrators with additional rights are specified for individual functional areas of the device. For example, an administrator can possess the authorisation to modify, store and delete forms that are processed by means of the device, while the information with which the form is filled out, such as addresses, for example, is inaccessible to this administrator. In addition, an administrator can be specified only for the creation and modification of work processes controlled by software, so-called workflows, by means of which the data processing activities can be largely automated. In addition, the responsibility for the creation and modification of data sets can be limited. Thus the responsibility and workload of the administrator is distributed to several administrators with partial responsibility.

According to a further advantageous embodiment, the means for limiting the access rights is designed in a way that makes possible the independent inheritance of access rights for the users. Thus the rights management is simplified to a certain degree, since the administrator is not required to assign rights to an additional user. For example, an initial user can assign to an additional user rights restricted with respect to the initial user, assign one or more of its rights, or “transfer” additional rights specifically provided for it. For example, an initial user who has access rights to specific storage location on the basis of his membership in a specific substructure in the organizational structure of his company can transfer this access to an additional user who does not have this right in order to be able to work on this data together. Through this so-called “four-eyes principle”, the management of the rights is especially simplified. The rights thus granted can be revoked again by the granting user by means of targeted revocation, or limited by means of the passage of time.

In a further advantageous embodiment, the inherited right is related to an object. Thus the inheritance of rights carried out by an individual user can occur in a particularly focused manner. An object can involve, for example, a table or, in a special application an individual record or even an individual file or text, which in each case are stored in the main memory of the device. This advantageously makes it possible, for example, for an initial user who possesses and is entitled to access a record electronically managed by means of the device, to process the data sets stored in this respect, to be able to authorise an additional user for the purpose of teamwork, and likewise to work on the record. The administration of rights is thus particularly reduced with respect to time- and personnel expense.

A further advantageous embodiment is specified, which corresponds the access rights of the individual users with a company structure. Rights management can thus be simplified. For example, the users who belong to a functional unit in the company structure, or are provided with corresponding equivalent responsibilities, are centralised in a user group. Because the rights need not be assigned to an individual user, but rather the corresponding user need merely be added to the group, the administrative expense associated with rights management is reduced. In addition to accessing objects and resources, the group-specific right can involve a so-called privilege, which represents in a certain way an authorisation to carry out certain actions, for example the creation of objects, for example of a table whose content is associated with a file transaction in the course of business.

In an advantageous embodiment of the device according to the invention, the data are created by a database and/or are managed by it. Just as with databases, efficient management of access rights is necessary for the comparatively large data sets associated with it. This embodiment involves a database with SQL query language (Structured Query Language). This has a comparatively simple syntax and makes available a series of commands for the definition of data structures according to relational algebra for the manipulation of data sets (creation, processing and deletion of data sets) and for querying data. Through its role as a quasi-standard, SQL is of great importance, since a large measure of independence from the software used can be achieved. In a further special embodiment, the user- and rights management is likewise realized by means of SQL.

In a further advantageous embodiment of the device according to the invention, the database is partitioned. For example, the tables belonging to the database are partitioned. At the same time, it involves an organisational form for the individual tables that is particularly advantageous for spatially distributed databases. A data set is divided among multiple, spatially distributed partitions of the individual tables, which can be separately managed in each case under the control of its own database management program. From the point of view of the application accessing the database, all data can be read and written via the name of the partitioned table. The indices belonging to a partitioned table can likewise be partitioned—based on independent or identical criteria such as the table itself. The access control can advantageously include all user and partition areas, in order to make possible the assignment and also the exchange of rights advantageously in such a way that users are allowed access to other partitioned database areas for which they had no actual access, for example on the basis of their position in the company structure.

In a further advantageous embodiment of the device according to the invention, the data include information about commercial intellectual property rights. In particular, the data that are associated with commercial intellectual property rights can be particularly sensitive in data security aspects such that the system according to the invention can be particularly advantageously used in this area. For example, if an intellectual property right is managed by several parts of the company as a joint applicant, the access for this joint object can be made possible for both parts of the company. This is achieved particularly easily in an embodiment by means of rights inheritance between the users.

The invention further relates to a method whereby the device described above is used with the advantages resulting from it, in order to limit and/or to grant a user access to data.

1. A device having a memory for data storage comprising means for limiting the access rights to the data storage for a user.

2. The device according to claim 1, wherein the means for limiting the access rights is controlled temporally.

3. The device according to claim 1, wherein the means for limiting the access rights is designed such that the user is granted unlimited access.

4. The device according to claim 1, wherein the means for limiting the access is specified, such that at least an allocation between the user and the access rights is ascertainable.

5. The device according to claim 1, wherein the means for limiting the access rights is designed in such a way that no user is granted unlimited access.

6. The device according to claim 1, wherein the means for limiting the access rights is designed such that independent inheritance of access rights is possible for the user.

7. The device according to claim 6, wherein the inherited access right inheritance of access rights is object-based.

8. The device according to claim 1, wherein the access rights of the user correspond to a company structure.

9. The device according to claim 1, wherein the data are created and/or managed by a database.

10. The device according to claim 9, wherein the database is a partitioned database.

11. The device according to claim 1, wherein the data include information about commercial intellectual property rights.

12. (canceled)

13. (canceled)

14. A data processing system for restricting user access rights comprising
(a) a computer processor means for processing data;
(b) storage means for storing data on a storage medium;
(c) means for limiting access to the stored data to individual users.

15. The data processing system according to claim 15, wherein the means for limiting access is designed such that no individual user has unlimited access rights.

16. A method for controlling user access to a database stored in a memory medium in a computer, the method comprising the steps of
(a) providing a computer processor for processing data;
(b) providing means for storing data on a storage medium;
(c) providing means for limiting access to the stored data.

17. The method for controlling user access to a database stored in a memory medium in a computer according to claim 16, wherein the provided means for storing the data includes Structural Query Language providing a plurality of commands designed for limiting access.

18. A data processing system for restricting user access rights comprising
(a) a computer processor means for processing data;
(b) storage means for storing data on a storage medium;
(c) means for limiting access to the stored data to individual users.
